(19) United States
(12) Patent Application Publication
(10) Pub. No.: US 2011/0039064 A1
(43) Pub. Date: Feb. 17, 2011

(54) FLEXIBLE CONDUCTIVE POLYMERIC SHEET

(75) Inventors: Vijay Wani, Lake Jackson, TX (US); Richard T. Fox, Midland, MI (US)

Correspondence Address: The Dow Chemical Company;Osha Liang LLP, Two Houston Center, 909 Fannin Street, Suite 3500, Houston, TX, 77010-2002, US

(73) Assignee: DOW GLOBAL TECHNOLOGIES INC., Midland, MI (US)

(21) Appl. No.: 12/526,488

(22) PCT Filed: Feb. 7, 2008
(86) PCT No.: PCT/US08/53331

§ 371 Date: Nov. 4, 2010

Related U.S. Application Data
(60) Provisional application No. 60/888,856, filed on Feb. 8, 2007.

(51) Int. Cl. B32B 27/00; B32B 5/16; B32B 27/12; B32B 3/10; B32B 3/26; B32B 7/02; B05D 5/12; H01B 1/12; H01B 1/24; H01B 1/22; H01B 1/20

(52) U.S. Cl. 428/137; 428/323; 442/110; 428/328; 428/304.4; 428/411.1; 428/212; 427/58; 427/122; 427/123; 427/126.3; 427/121; 252/500; 252/511; 252/512; 252/519.33

(57) ABSTRACT

An electrically conductive article including a substrate and at least one electrically conductive layer disposed on the substrate. The conductive layer may include a thermoplastic resin and from about 1 to 30 weight percent of at least one conductive additive based on a total weight of the thermoplastic resin and the at least one conductive additive. The conductive article may have a surface resistance between 0.001 to 20Ω at a test distance of 2.54 cm (1 inch).

### BACKGROUND OF INVENTION

1. Field of the Invention

Embodiments disclosed herein relate generally to a conductive coating composition and formation of conductive polymeric sheets using the same.

2. Background

Electrostatic dissipation is often required for electronic packaging applications. Films fabricated using inherently conductive polymers (ICPs) or films filled with conductive particles are typically used to dissipate the electrostatic energy. For example, U.S. Pat. No. 4,803,096 discloses various ICPs, and U.S. Pat. No. 5,804,291 discloses use of conductive particles dispersed in a non-conducting matrix.

Electrically conductive fabrics have also been formed by incorporating conductive fibers or yarns into the fabric, such as by weaving, knitting, or stitching. The conductive fibers or yarns may be incorporated in the form of a grid to increase the effectiveness of the conductive fibers and yarns. Examples of these antistatic fabrics are disclosed in U.S. Pat. Nos. 4,557,968 and 4,606,968.

Other conductive fabrics have been formed by coating a substrate with a conductive polymer, and then removing selected portions of the conductive polymer. For example, U.S. Pat. No. 5,624,736 discloses a method in which a substrate is coated with a conductive polymer across its entire surface. The fabric is then coated in select areas with a protective film. The substrate is then subjected to a third treatment in which a chemical etching agent is used to remove the conductive polymer from the exposed portions of the substrate which were not covered with the protective film. Finally, the substrate is rinsed to remove the excess etching agent.

U.S. Pat. No. 6,576,336 discloses an electrically conductive or electromagnetic radiation absorptive coating composition having a water soluble emulsion polymer binder. The binder is a blend of a first emulsion containing a conjugated diene monomer or comonomer, such as non-carboxylated butadiene-acrylonitrile latex, and a second emulsion containing an acrylic polymer. The coating composition also contains an effective amount of electrically conductive particles dispersed in the binder, such as graphite particles, and metal containing particles, such as silver or nickel containing particles.

Other forms of conductive materials and coatings are disclosed in U.S. Patent Application Publications Nos. 20040053552, 20050199861, and 20060086927, and PCT Publications WO1995034423, WO2005114324, WO2005123847, WO2006008518, and WO2006035112.

Several of the above described conductive polymers, yarns, and films are inherently highly colored. The inherent color may result in limited color ranges for the final product, or may affect the appearance of the end product as the conductive polymers need to be located at the surface to be effective.

Another drawback to the ICPs and conductive fillers described above is that they typically involve the use of expensive raw materials. Additionally, these conductive materials may degrade over time, reducing the performance of the conductive films and fabrics.

Accordingly, there exists a need for lower cost alternatives to current ICPs and films containing conductive particles. There also exists a need for conductive films that may be tinted to a wide variety of colors. Additionally, there exists a need for conductive fabrics and films that perform adequately following exposure to aging, including time and temperature aging.

### SUMMARY OF INVENTION

In one aspect, embodiments disclosed herein relate to an electrically conductive article. The article may include a substrate and at least one electrically conductive layer disposed on the substrate. The conductive layer may include a thermoplastic resin and from about 1 to 30 weight percent of at least one conductive additive based on a total weight of the thermoplastic resin and the at least one conductive additive. The conductive article may have a surface resistance between 0.001 to 20Ω at a test distance of 2.54 cm (1 inch).

In other aspects, embodiments disclosed herein relate to a method of making an electrically conductive article. The method may include applying at least one electrically conductive layer to a substrate, wherein the electrically conductive layer may include a thermoplastic resin and at least one electrically conductive additive, wherein the conductive additive comprises from about 1 to 30 percent of a total weight of the thermoplastic resin and the at least one conductive additive, and wherein the conductive article has a surface resistance between 0.001 to 20Ω at a test distance of 2.54 cm (1 inch).

In other aspects, embodiments disclosed herein relate to an aqueous dispersion including a thermoplastic resin, at least one stabilizing agent, at least one electrically conductive additive, and water.

Other aspects and advantages of the invention will be apparent from the following description and the appended claims.

### BRIEF DESCRIPTION OF DRAWINGS

FIG. 1 illustrates a cross-section of a conductive polymeric sheet in accordance with embodiments disclosed herein.

### DETAILED DESCRIPTION

In one aspect, embodiments disclosed herein relate generally to electrically conductive polymeric sheets. In other aspects, embodiments disclosed herein relate to flexible electrically conductive polymeric sheets.

In some embodiments, an electrically conductive polymeric sheet may be formed by deposition of a polymeric or elastomeric composition including electrically conductive additives on one or more surfaces of a polymeric substrate. The substrate may be non-conductive, as an electrically conductive coating deposited on the surface of a non-conductive substrate may efficiently dissipate charges transferred from objects which come into contact with the conductive polymeric sheet.

In other embodiments, an electrically conductive polymeric sheet may be formed by incorporating a polymeric or elastomeric composition including electrically conductive additives into a porous substrate. Porous substrates may include various fabrics and foams, including non-woven fabrics and open-celled foams. Where a porous substrate is used, electrical contact may be established through the pore spaces, allowing for electrical conductivity to exist on both sides of a substrate. Additionally, differing basis weights and substrate characteristics may be selected to control the electrical conductivity.

In other embodiments, an electrically conductive polymeric sheet may be formed by deposition of a polymeric or elastomeric coating including electrically conductive additives on both sides of a substrate. The coating used on either side may contain the same or different electrically conductive additives or concentrations of electrically conductive additives. In some embodiments, an electrically conductive polymeric sheet may be coated on both sides such that the electrical conductivity of one side of the conductive polymeric sheet is greater or less than the electrical conductivity of the other side.

The electrically conductive polymeric sheets described in various embodiments may be useful in electrostatic dissipation applications. The electrically conductive polymeric sheets and electrically conductive polymeric or elastomeric compositions may also be used in applications such as light weight electromagnetic shielding, paintable antennae, corrosion resistant coatings, conductive coatings and paints, and other various applications.

Some of the electrically conductive coatings and substrates useful in embodiments disclosed herein may be formed from dispersions, froths, and foams. For example, coatings or foams useful in embodiments of the electrically conductive polymeric sheets may be formed from froths or frothed dispersions. As used herein, the terms “frothing” or “frothed” refers to a process where substantial volumes of air, or other gas, are incorporated in a liquid where, in some embodiments, at least 80 volume percent of the resulting composition (the frothed material) consists of the gaseous component. In other embodiments, at least 85 volume percent of the frothed material consists of the gaseous component; and at least 90 volume percent in yet other embodiments. The liquid may be a molecular solution, micellar solution, or dispersion in an aqueous or organic medium. In general the frothed liquid is created by mechanical methods such as high shear mixing under atmospheric conditions or optionally injecting gas into the system while mixing. The term “froth,” as used herein, refers to a liquid which has been frothed, as described above, before drying or removing the liquid medium.

The term “foam,” as used herein, refers to a resilient structure formed by removing a portion of the liquid medium from a froth, i.e., at least a portion, a substantial portion, or all of the liquid medium may be removed. As used herein, drying and removing may be used interchangeably, and may include thermal and/or mechanical removal of the liquid medium. The formation of foams from froths in accordance with embodiments disclosed herein is may be described as follows. A froth may include pockets of vapor within a dispersion, where the dispersion includes conductive additive and polymer particles in a liquid medium. When the liquid medium is removed from the froth during a drying or removing process, the polymer particles may coalesce and melt together creating an interconnected film or struts around the entrapped vapor bubbles, giving stability to the resulting structure. Film formation may depend upon variables including the melting point of polymers within the froth, the rate of removal (i.e., evaporation rate) of the liquid medium, and overall froth composition, among others. For example, as water is removed from a froth formed from an aqueous dispersion, polymers contained in the dispersion may coalesce, forming a film, giving structure and resiliency to the resulting foam. In some embodiments, foams may be formed where the amount of residual liquid ranges from 0 to 20 weight percent; 0 to 10 weight percent in other embodiments; and 0 to 8 percent in yet other embodiments.

As described above, embodiments of the electrically conductive polymeric sheets may include various substrates, including non-wovens, fabrics, and foams. Coatings may be formed from dispersions, froths, and foams, each of which may include additives such as dispersion stabilizing agents, frothing surfactants, and other additives. Additionally, embodiments of the conductive coatings disclosed herein include conductive additives. Each of these components and methods to form the electrically conductive polymeric sheets disclosed herein are described in more detail below.

Polymeric Coating

Coatings useful in embodiments may include coatings formed from thermoplastic resins. In some embodiments, coatings may be made from aqueous dispersions. The aqueous dispersions, in some embodiments, may be frothed and/or may be at least partially dried to result in the desired coatings. Dispersions used in embodiments of the present disclosure comprise water, at least one thermoplastic resin, and a dispersion stabilizing agent. The thermoplastic resin included in embodiments of the coatings may include a resin that is not readily dispersible in water by itself. The term “resin,” as used herein, should be construed to include synthetic polymers or chemically modified natural resins. In some embodiments, the thermoplastic resin may include polyolefins. Dispersions may also include various additives, including froth stabilizing agents.

Thermoplastic Resin

Thermoplastic resins used herein may include olefin polymers and elastomers, and blends of various olefin polymers and/or olefin elastomers. In some embodiments, the olefin resin is a semicrystalline resin. The term “semi-crystalline” is intended to identify those resins that possess at least one endotherm when subjected to standard differential scanning calorimetry (DSC) evaluation. Some semi-crystalline polymers exhibit a DSC endotherm that exhibits a relatively gentle slope as the scanning temperature is increased past the final endotherm maximum. This reflects a polymer of broad melting range rather than a polymer having what is generally considered to be a sharp melting point. Some polymers useful in the dispersions of the disclosure have a single melting point while other polymers have more than one melting point.

In some polymers, one or more of the melting points may be sharp such that all or a portion of the polymer melts over a fairly narrow temperature range, such as a few degrees centigrade. In other embodiments, the polymer may exhibit broad melting characteristics over a range of about 20° C. In yet other embodiments, the polymer may exhibit broad melting characteristics over a range of greater than 50° C.

Examples of the olefin resins that may be used in the present disclosure include homopolymers and copolymers (including elastomers) of an alpha-olefin such as ethylene, propylene, 1-butene, 3-methyl-1-butene, 4-methyl-l-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer; styrenic copolymers (including elastomers) such as polystyrene, ABS, acrylonitrile-styrene copolymer, α-methylstyrene-styrene copolymer, styrene vinyl alcohol, styrene acrylates such as styrene methylacrylate, styrene butyl acrylate, styrene butyl methacrylate, and styrene butadienes and crosslinked styrene polymers; and styrene block copolymers (including elastomers) such as styrene-butadiene copolymer and hydrates thereof, and styrene-isoprene-styrene tri-block copolymer; polyvinyl compounds such as polyvinyl chloride, polyvinylidene chloride, vinyl chloride-vinylidene chloride copolymer, polymethyl acrylate, and polymethyl methacrylate; polyamides such as nylon 6, nylon 6,6, and nylon 12; thermoplastic polyesters such as polyethylene terephthalate and polybutylene terephthalate; polycarbonate, polyphenylene oxide, and the like; and glassy hydrocarbon-based resins, including poly-dicyclopentadiene polymers and related polymers (copolymers, terpolymers); saturated mono-olefins such as vinyl acetate, vinyl propionate and vinyl butyrate and the like; vinyl esters such as esters of monocarboxylic acids, including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate and the like; acrylonitrile, methacrylonitrile, acrylamide, mixtures thereof; resins produced by ring opening metathesis and cross metathesis polymerization and the like. These resins may be used either alone or in combinations of two or more.

In particular embodiments, the thermoplastic resin may be a styrene-butadiene copolymer. For example, the styrene-butadiene copolymer may be provided in the form of surfactant stabilized styrene-butadiene copolymer latex, such as TYKOTE® and the DL series of styrene-butadiene copolymer latexes available from The Dow Chemical Company. For example, DL460, available from The Dow Chemical Company, has approximately 46-49 weight percent non-volatile components, a pH of approximately 10, and a glass transition temperature of approximately 4° C.

In one particular embodiment, the thermoplastic resin may comprise an alpha-olefin interpolymer of ethylene with a comonomer comprising an alkene, such as 1-octene. The ethylene and octene copolymer may be present alone or in combination with another thermoplastic resin, such as ethylene-acrylic acid copolymer. When present together, the weight ratio between the ethylene and octene copolymer and the ethylene-acrylic acid copolymer may range from about 1:10 to about 10:1, such as from about 3:2 to about 2:3. The polymeric resin, such as the ethylene-octene copolymer, may have a crystallinity of less than about 50%, such as less than about 25%. In some embodiments, the crystallinity of the polymer may range from 5 to 35 percent. In other embodiments, the crystallinity may range from 7 to 20 percent.

Embodiments disclosed herein may also include a polymeric component that may include at least one multi-block olefin interpolymer. Suitable multi-block olefin interpolymers may include those described in, for example, U.S. Provisional Patent Application No. 60/818,911, incorporated herein by reference. The term “multi-block copolymer” or “multi-block interpolymer” refers to a polymer comprising two or more chemically distinct regions or segments (referred to as “blocks”) preferably joined in a linear manner, that is, a polymer comprising chemically differentiated units which are joined end-to-end with respect to polymerized ethylenic functionality, rather than in pendent or grafted fashion. In certain embodiments, the blocks differ in the amount or type of comonomer incorporated therein, the density, the amount of crystallinity, the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property.

Other olefin interpolymers include polymers comprising monovinylidene aromatic monomers including styrene, o-methyl styrene, p-methyl styrene, t-butylstyrene, and the like. In particular, interpolymers comprising ethylene and styrene may be used. In other embodiments, copolymers comprising ethylene, styrene and a C₃-C₂₀ α olefin, optionally comprising a C₄-C₂₀ diene, may be used.

Suitable non-conjugated diene monomers may include straight chain, branched chain or cyclic hydrocarbon diene having from 6 to 15 carbon atoms. Examples of suitable non-conjugated dienes include, but are not limited to, straight chain acyclic dienes, such as 1,4-hexadiene, 1,6-octadiene, 1,7-octadiene, 1,9-decadiene, branched chain acyclic dienes, such as 5-methyl-1,4-hexadiene; 3,7-dimethyl-1,6-octadiene; 3,7-dimethyl-1,7-octadiene and mixed isomers of dihydromyricene and dihydroocinene, single ring alicyclic dienes, such as 1,3-cyclopentadiene; 1,4-cyclohexadiene; 1,5-cyclooctadiene and 1,5-cyclododecadiene, and multi-ring alicyclic fused and bridged ring dienes, such as tetrahydroindene, methyl tetrahydroindene, dicyclopentadiene, bicyclo-(2,2,1)-hepta-2,5-diene; alkenyl, alkylidene, cycloalkenyl and cycloalkylidene norbornenes, such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and norbornadiene. Of the dienes typically used to prepare EPDMs, the particularly preferred dienes are 1,4-hexadiene (HD), 5-ethylidene-2-norbornene (ENB), 5-vinylidene-2-norbornene (VNB), 5-methylene-2-norbornene (MNB), and dicyclopentadiene (DCPD).

One class of desirable polymers that may be used in accordance with embodiments disclosed herein includes elastomeric interpolymers of ethylene, a C₃-C₂₀ α-olefin, especially propylene, and optionally one or more diene monomers. Preferred α-olefins for use in this embodiment are designated by the formula CH₂═CHR*, where R* is a linear or branched alkyl group of from 1 to 12 carbon atoms. Examples of suitable α-olefins include, but are not limited to, propylene, isobutylene, 1-butene, 1-pentene, 1-hexene, 4-methyl-1-pentene, and 1-octene. The propylene-based polymers are generally referred to in the art as EP or EPDM polymers. Suitable dienes for use in preparing such polymers, especially multi-block EPDM type polymers, include conjugated or non-conjugated, straight or branched chain-, cyclic- or polycyclic-dienes comprising from 4 to 20 carbon atoms. Dienes may include 1,4-pentadiene, 1,4-hexadiene, 5-ethylidene-2-norbornene, dicyclopentadiene, cyclohexadiene, and 5-butylidene-2-norbornene.

Other suitable thermoplastic resins may include the esterification products of a di- or poly-carboxylic acid and a diol comprising a diphenol. These resins are illustrated in U.S. Pat. No. 3,590,000, which is incorporated herein by reference. Other specific examples of resins include styrene/methacrylate copolymers, and styrene/butadiene copolymers; suspension polymerized styrene butadienes; polyester resins obtained from the reaction of bisphenol A and propylene oxide followed by the reaction of the resulting product with fumaric acid; and branched polyester resins resulting from the reaction of dimethylterephthalate, 1,3-butanediol, 1,2-propanediol, and pentaerythritol, styrene acrylates, and mixtures thereof.

Further, specific embodiments of the present disclosure may employ ethylene-based polymers, propylene-based polymers, propylene-ethylene copolymers, and styrenic copolymers as one component of a composition. Other embodiments of the present disclosure may use polyester resins, including those containing aliphatic diols such as UNOXOL 3,4 diol, available from The Dow Chemical Company (Midland, Mich.).

In select embodiments, the thermoplastic resin is formed from ethylene-alpha olefin copolymers or propylene-alpha olefin copolymers. In particular, in select embodiments, the thermoplastic resin includes one or more non-polar polyolefins.

In specific embodiments, polyolefins such as polypropylene, polyethylene, copolymers thereof, and blends thereof, as well as ethylene-propylene-diene terpolymers, may be used. In some embodiments, olefinic polymers may include homogeneous polymers, as described in U.S. Pat. No. 3,645,992 issued to Elston; high density polyethylene (HDPE), as described in U.S. Pat. No. 4,076,698 issued to Anderson; heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers, which can be prepared, for example, by processes disclosed in U.S. Pat. Nos. 5,272,236 and 5,278,272, the disclosures of which are incorporated herein by reference; and high pressure, free radical polymerized ethylene polymers and copolymers such as low density polyethylene (LDPE) or ethylene vinyl acetate polymers (EVA).

Polymer compositions, and blends thereof, described in U.S. Pat. Nos. 6,566,446, 6,538,070, 6,448,341, 6,316,549, 6,111,023, 5,869,575, 5,844,045, or 5,677,383, each of which is incorporated herein by reference in its entirety, may also be suitable in some embodiments. In some embodiments, the blends may include two different Ziegler-Natta polymers. In other embodiments, the blends may include blends of a Ziegler-Natta polymer and a metallocene polymer. In still other embodiments, the polymer used herein may be a blend of two different metallocene polymers. In other embodiments, single site catalyst polymers may be used.

In some embodiments, the polymer is a propylene-based copolymer or interpolymer. In some particular embodiments, the propylene/ethylene copolymer or interpolymer is characterized as having substantially isotactic propylene sequences. The term “substantially isotactic propylene sequences” and similar terms mean that the sequences have an isotactic triad (mm) measured by ¹³C NMR of greater than about 0.85 in one embodiment; greater than about 0.90 in another embodiment; greater than about 0.92 in another embodiment; and greater than about 0.93 in yet another embodiment. Isotactic triads are well-known in the art and are described in, for example, U.S. Pat. No. 5,504,172 and WO 00/01745, which refer to the isotactic sequence in terms of a triad unit in the copolymer molecular chain determined by ¹³C NMR spectra.

The olefin polymers, copolymers, interpolymers, and multi-block interpolymers may be functionalized by incorporating at least one functional group in its polymer structure. Exemplary functional groups may include, for example, ethylenically unsaturated mono- and di-functional carboxylic acids, ethylenically unsaturated mono- and di-functional carboxylic acid anhydrides, salts thereof and esters thereof. Such functional groups may be grafted to an olefin polymer, or it may be copolymerized with ethylene and an optional additional comonomer to form an interpolymer of ethylene, the functional comonomer and optionally other comonomer(s). Means for grafting functional groups onto polyethylene are described for example in U.S. Pat. Nos. 4,762,890, 4,927,888, and 4,950,541, the disclosures of which are incorporated herein by reference in their entirety. One particularly useful functional group is maleic anhydride.

The amount of the functional group present in the functional polymer may vary. The functional group may be present in an amount of at least about 1 weight percent in some embodiments; at least about 5 weight percent in other embodiments; and at least about 7 weight percent in yet other embodiments. The functional group may be present in an amount less than about 40 weight percent in some embodiments; less than about 30 weight percent in other embodiments; and less than about 25 weight percent in yet other embodiments.

In other particular embodiments, the thermoplastic resin may be ethylene vinyl acetate (EVA) based polymers. In other embodiments, the thermoplastic resin may be ethylene-methyl acrylate (EMA) based polymers. In other particular embodiments, the ethylene-alpha olefin copolymer may be ethylene-butene, ethylene-hexene, or ethylene-octene copolymers or interpolymers. In other particular embodiments, the propylene-alpha olefin copolymer may be a propylene-ethylene or a propylene-ethylene-butene copolymer or interpolymer.

The thermoplastic polymer may have a crystallinity as determined by the observance of at least one endotherm when subjected to standard differential scanning calorimetry (DSC) evaluation. For ethylene-based polymers, a melt index (“MI”) determined according to ASTM D1238 at 190° C. (375° F.) with a 2.16 kg (4.75 lb.) weight of about 30 g/10 minutes or less in some embodiments; about 25 g/10 minutes or less in other embodiments; about 22 g/10 minutes or less in other embodiments; and about 18 g/10 minutes or less in yet other embodiments. In other embodiments, ethylene-based polymers may have a melt index (MI) of about 0.1 g/10 minutes or greater; about 0.25 g/10 minutes or greater in other embodiments; about 0.5 g/10 minutes or greater in other embodiments; and about 0.75 g/10 minutes or greater in yet other embodiments.

Propylene-based polymers may have a Melt Flow Rate (“MFR”) determined according to ASTM D1238 at 230° C. (446° F.) with a 2.16 kg (4.75 lb.) weight of about 85 g/10 minutes or less in some embodiments; about 70 g/10 minutes or less in other embodiments; about 60 g/10 minutes or less in other embodiments; and about 50 g/10 minutes or less in yet other embodiments. In other embodiments, propylene-based polymers may have a melt flow rate (MFR) of about 0.25 g/10 minutes or greater; about 0.7 g/10 minutes or greater in other embodiments; about 1.4 g/10 minutes or greater in other embodiments; and about 2 g/10 minutes or greater in yet other embodiments.

Ethylene-based polymers may have a density of about 0.845 g/cc or greater in some embodiments; about 0.85 g/cc or greater in other embodiments; about 0.855 g/cc or greater in other embodiments; and about 0.86 g/cc or greater in yet other embodiments. In other embodiments, ethylene-based polymers may have a density of about 0.97 g/cc or less; about 0.96 g/cc or less in other embodiments; about 0.955 g/cc or less in other embodiments; and about 0.95 g/cc or less in yet other embodiments.

Propylene-based polymers may comprise about 5 percent by weight comonomer or greater in some embodiments. In other embodiments, propylene-based polymers may comprise about 7 percent by weight comonomer or greater. In other embodiments, propylene-based polymers may contain about 35 percent or less comonomer by weight; about 25 percent or less comonomer by weight in yet other embodiments.

One class of thermoplastic polymers useful in various embodiments are copolymers of ethylene and 1-octene or 1-butene, where the ethylene copolymer contains about 90 weight percent or less ethylene; about 85 weight percent or less ethylene in other embodiments; about 50 weight percent or greater ethylene in other embodiments; and about 55 weight percent or greater ethylene in yet other embodiments. The ethylene copolymer may contain 1-octene or 1-butene from about 10 weight percent or greater in some embodiments; about 15 weight percent or greater in other embodiments; about 50 weight percent or less in other embodiments; and about 45 weight percent or less in yet other embodiments. Each of the above weight percentages are based on the weight of the copolymer. In various embodiments, the ethylene copolymers may have a Melt Index of about 0.25 g/10 minutes or greater; about 0.5 g/10 minutes or greater in other embodiments; about 30 g/10 minutes or less in other embodiments; and about 20 g/10 minutes or less in yet other embodiments.

Other polymers useful in embodiments may include copolymers of propylene and ethylene, 1-octene, 1-hexene or 1-butene, where the propylene copolymer contains from about 95 weight percent or less propylene; about 93 weight percent or less in other embodiments; about 65 weight percent or greater in other embodiments; and about 75 weight percent or greater in yet other embodiments. The propylene copolymer may contain one or more comonomers, such as ethylene, 1-octene, 1-hexene or 1-butene, from about 5 weight percent or greater in some embodiments; about 7 weight percent or greater in other embodiments; about 35 weight percent or less in other embodiments; and 25 weight percent or less in yet other embodiments. In various embodiments, the propylene copolymers may have a Melt Flow Rate of about 0.7 g/10 minutes or greater; about 1.4 g/10 minutes or greater in other embodiments; about 85 g/10 minutes or less in other embodiments; and about 55 g/10 minutes or less in yet other embodiments.

Alternatively, instead of a single polymer, a blend of polymers may be employed that has the physical characteristics described herein. For example, it may be desirable to blend a first polymer with relatively high MI or MFR that is outside the range described, with another of relatively low MI or MFR, so that the combined MI or MFR and the averaged density of the blend fall within the described ranges. A more crystalline alpha-olefin polymer may be combined with one of relatively lower crystallinity, such as one having a significant amount of long chain branching, to provide a blend that has substantially equivalent processing capability in preparing froths and foams described herein. Where reference is made to a “polymer” in this specification, it is understood that blends of olefin polymers with equivalent physical characteristics may be employed with like effect and are considered to fall within our description of the various embodiments.

In certain embodiments, the thermoplastic resin may be an ethylene-octene copolymer or interpolymer having a density between 0.857 and 0.911 g/cc and melt index (190° C. with 2.16 kg weight) from 0.1 to 100 g/10 min. In other embodiments, the ethylene-octene copolymers may have a density between 0.863 and 0.902 g/cc and melt index (190° C. with 2.16 kg weight) from 0.8 to 35 g/10 min. The ethylene-octene copolymer or interpolymer may incorporate 20-45 percent octene by weight of ethylene and octene.

In certain embodiments, the thermoplastic resin may be a propylene-ethylene copolymer or interpolymer having an ethylene content between 5 and 20% by weight and a melt flow rate (230° C. with 2.16 kg weight) from 0.5 to 300 g/10 min. In other embodiments, the propylene-ethylene copolymer or interpolymer may have an ethylene content between 9 and 12 percent by weight and a melt flow rate (230° C. with 2.16 kg weight) from 1 to 100 g/10 min.

In certain other embodiments, the thermoplastic resin may be a low density polyethylene having a density between 0.911 and 0.925 g/cc and melt index (190° C. with 2.16 kg weight) from 0.1 to 100 g/10 min.

In some embodiments, the thermoplastic resin may have a crystallinity of less than 50 percent. In other embodiments, the crystallinity of the resin may be from 5 to 35 percent. In yet other embodiments, the crystallinity may range from 7 to 20 percent.

In some embodiments, the thermoplastic resin is a semi-crystalline polymer and may have a melting point of less than 110° C. In other embodiments, the melting point may be from 25 to 100° C. In yet other embodiments, the melting point may be between 40 and 85° C.

In some embodiments, the thermoplastic resin is a glassy polymer and may have a glass transition temperature of less than 110° C. In other embodiments, the glass transition temperature may be from 20 to 100° C. In yet other embodiments, the glass transition temperature may be from 50 to 75° C.

In certain embodiments, the thermoplastic resin may have a weight average molecular weight greater than 10,000 g/mole. In other embodiments, the weight average molecular weight may be from 20,000 to 150,000 g/mole; in yet other embodiments, from 50,000 to 100,000 g/mole.

The one or more thermoplastic resins may be contained within the aqueous dispersions described herein in an amount from about 1 percent by weight to about 96 percent by weight polymer solids. For instance, the thermoplastic resin may be present in the aqueous dispersion in an amount from about 10 percent by weight to about 60 percent by weight in one embodiment, and about 20 percent to about 50 percent by weight in another embodiment.

Dispersion Stabilizing Agent

Dispersions of the above described thermoplastic resins may use a stabilizing agent to promote the formation of a stable dispersion or emulsion. In some embodiments, the stabilizing agent may be a surfactant, a polymer (different from the thermoplastic resin detailed above), or mixtures thereof. In other embodiments, the resin is a self-stabilizer, such that an additional exogenous stabilizing agent may not be necessary. For example, a self-stabilizing system may include a partially hydrolyzed polyester, where by combining polyester with an aqueous base, a polyester resin and a surfactant-like stabilizer molecule may be produced. In particular, the stabilizing agent may be used as a dispersant, a surfactant for frothing the dispersion, or may serve both purposes. In addition, one or more stabilizing agents may be used in combination.

In certain embodiments, the stabilizing agent may be a polar polymer, having a polar group as either a comonomer or grafted monomer. In preferred embodiments, the stabilizing agent may include one or more polar polyolefins, having a polar group as either a comonomer or grafted monomer. Typical polymers include ethylene-acrylic acid (EAA) and ethylene-methacrylic acid copolymers, such as those available under the trademarks PRIMACOR™ (trademark of The Dow Chemical Company), NUCREL™ (trademark of E.I. DuPont de Nemours), and ESCOR™ (trademark of ExxonMobil) and described in U.S. Pat. Nos. 4,599,392, 4,988,781, and 5,938,437, each of which is incorporated herein by reference in its entirety. Other suitable polymers include ethylene ethyl acrylate (EEA) copolymer, ethylene methyl methacrylate (EMMA), and ethylene butyl acrylate (EBA). Other ethylene-carboxylic acid copolymer may also be used. Those having ordinary skill in the art will recognize that a number of other useful polymers may also be used.

If the polar group of the polymer is acidic or basic in nature, the dispersion stabilizing polymer may be partially or fully neutralized with a neutralizing agent to form the corresponding salt. The salts may be alkali metal or ammonium salts of the fatty acid, prepared by neutralization of the acid with the corresponding base, e.g., NaOH, KOH, and NH₄OH. These salts may be formed in situ in the dispersion step, as described more fully below. In certain embodiments, neutralization of the dispersion stabilizing agent, such as a long chain fatty acid or EAA, may be from 25 to 200% on a molar basis; from 50 to 110% on a molar basis in other embodiments. For example, for EAA, the neutralizing agent is a base, such as ammonium hydroxide or potassium hydroxide, for example. Other neutralizing agents may include lithium hydroxide or sodium hydroxide, for example. Those having ordinary skill in the art will appreciate that the selection of an appropriate neutralizing agent depends on the specific composition formulated, and that such a choice is within the knowledge of those of ordinary skill in the art.

Other dispersion stabilizing agents that may be used include long chain fatty acids or fatty acid salts having from 12 to 60 carbon atoms. In other embodiments, the long chain fatty acid or fatty acid salt may have from 12 to 40 carbon atoms.

Additional dispersion stabilizing agents include cationic surfactants, anionic surfactants, or non-ionic surfactants. Examples of anionic surfactants include sulfonates, carboxylates, and phosphates. Examples of cationic surfactants include quaternary amines. Examples of non-ionic surfactants include block copolymers containing ethylene oxide, propylene oxide, butylene oxide, and silicone surfactants. Surfactants useful as a dispersion stabilizing agent may be either external surfactants or internal surfactants. External surfactants are surfactants that do not become chemically reacted into the polymer during dispersion preparation. Examples of external surfactants useful herein include salts of dodecyl benzene sulfonic acid and lauryl sulfonic acid salt. Internal surfactants are surfactants that do become chemically reacted into the polymer during dispersion preparation. An example of an internal surfactant useful herein includes 2,2-dimethylol propionic acid and its salts or sulfonated polyols neutralized with ammonium chloride.

In particular embodiments, the dispersing agent or stabilizing agent may be used in an amount ranging from greater than zero to about 60% by weight based on the amount of thermoplastic resin (or thermoplastic resin mixture) used. With respect to the thermoplastic resin and the dispersion stabilizing agent, in some embodiments, the thermoplastic resin may comprise between about 30% to 99% (by weight) of the total amount of thermoplastic resin and dispersion stabilizing agent in the composition. In other embodiments, the thermoplastic resin may comprise between about 50% and about 80% (by weight) of the total amount of thermoplastic resin and dispersion stabilizing agent in the composition. In yet other embodiments, the thermoplastic resins may comprise about 70% (by weight) of the total amount of thermoplastic resin and dispersion stabilizing agent in the composition. For example, long chain fatty acids or salts thereof may be used from 0.5 to 10% by weight based on the amount of thermoplastic resin. In other embodiments, ethylene-acrylic acid or ethylene-methacrylic acid copolymers may be used in an amount from 0.5 to 60% by weight based on the amount of the thermoplastic resin. In yet other embodiments, sulfonic acid salts may be used in an amount from 0.5 to 10% by weight based on the amount of thermoplastic resin.

As discussed above, more than one dispersion stabilizing agent may be used, and combinations may be used as a dispersion stabilizing agent and as a frothing surfactant, for example. One of ordinary skill in the art will recognize that the dispersants used to create a relatively stable aqueous dispersion may vary depending on the nature of the thermoplastic resin employed.

Dispersion Formulations

Dispersion formulations in accordance with embodiments disclosed herein may include a liquid medium, such as water, a thermoplastic resin, a dispersion stabilizing agent, and optionally frothing surfactants, additives, and fillers. In some embodiments, the aqueous dispersions may include polyolefin resin particles ranging in size from about 0.2 to 10 microns; from about 0.5 to 5 microns in another embodiment; and from about 1 to 2 microns.

The thermoplastic resin and the dispersion stabilizing agent may be dispersed in a liquid medium, which in some embodiments is water. In some embodiments, sufficient base is added to neutralize the resultant dispersion to achieve a pH range of about 6 to about 14. In particular embodiments, sufficient base is added to maintain a pH between about 9 to about 12. Water content of the dispersion may be controlled so that the combined content of the thermoplastic resin and the dispersion stabilizing agent (solids content) is between about 1% to about 74% (by volume). In another embodiment, the solids content ranges between about 25% to about 74% (by volume). In yet another embodiment, the solid content ranges between about 30% to about 50% (without filler, by weight). In yet another embodiment, the solids content ranges is between about 40% to about 55% (without filler, by weight).

Dispersions formed in accordance with some embodiments may be characterized in having an average particle size of between about 0.3 to about 5.0 microns. In other embodiments, dispersions may have an average particle size of from about 0.8 to about 1.2 microns. “Average particle size” as used herein refers to the volume-mean particle size. In order to measure the particle size, laser-diffraction techniques may be employed for example. A particle size in this description refers to the diameter of the polymer in the dispersion. For polymer particles that are not spherical, the diameter of the particle is the average of the long and short axes of the particle. Particle sizes can be measured on a Beckman-Coulter LS230 laser-diffraction particle size analyzer or other suitable device.

In a specific embodiment, a thermoplastic resin and a dispersion stabilizing agent are melt-kneaded in an extruder along with water and a neutralizing agent, such as ammonia, potassium hydroxide, or a combination of the two, to form a dispersion compound. Those having ordinary skill in the art will recognize that a number of other neutralizing agents may be used. In some embodiments, a filler may be added after blending the thermoplastic resin and stabilizing agent.

Any melt-kneading means known in the art may be used. In some embodiments, a kneader, a BANBURY® mixer, single-screw extruder, or a multi-screw extruder is used. A process for producing the dispersions in accordance with the present disclosure is not particularly limited. One preferred process, for example, is a process comprising melt-kneading the above-mentioned components according to U.S. Pat. No. 5,756,659 and U.S. Patent Publication No. 20010011118.

An extrusion apparatus that may be used in embodiments of the disclosure may be described as follows. An extruder, in certain embodiments a twin screw extruder, may be coupled to a back pressure regulator, melt pump, or gear pump. Desired amounts of base and initial water are provided from a base reservoir and an initial water reservoir, respectively. Any suitable pump may be used, but in some embodiments a pump that provides a flow of about 150 cc/min at a pressure of 240 bar may be used to provide the base and the initial water to the extruder. In other embodiments, a liquid injection pump may provide a flow of 300 cc/min at 200 bar or 600 cc/min at 133 bar. In some embodiments, the base and initial water are preheated in a preheater.

In producing the dispersion, the dispersion stabilizing surfactants are generally added to the dispersion along with antioxidants, bactericides, etc., when viscosity is low and good mixing may be obtained. The dispersion stabilizing agents should then be added followed by any inorganic fillers, slowly enough to ensure good dispersion and avoid clumping/lumping of the filler. Finally a thickener may be added to obtain the desired viscosity.

Frothing Surfactants

Surfactants useful for preparing froths are referred to herein as frothing surfactants. A frothing surfactant allows the gas, commonly air, used in frothing to disperse homogenously and efficiently into the formulated foamed dispersion. Preferably, the frothing surfactant produces a non-sudsing composite foam product after drying.

Embodiments of the present disclosure may use a frothing surfactant to promote the formation of a stable dispersion and to aid in frothing. Creating and stabilizing the froth during the frothing and drying steps may be accomplished by addition of a froth stabilizing surfactant to the aqueous dispersion of the polyolefin resin when initially creating the froth. In addition, these surfactants may also be used to improve aqueous wetting of dried foams, if desired. Suitable frothing surfactants may be selected from cationic, nonionic and anionic surfactants. In some embodiments, frothing surfactants may include the stabilizing agents as described above.

In some embodiments, the frothing surfactant may be an alkylcellulose ethers, hydroxyalkyl cellulose ethers, hydroxyalkyl alkylcellulose ethers, guar gum, xanthan gum, and polyoxyethylene resins of at least 20,000 molecular weight, or combinations thereof. Other suitable frothing surfactants may be selected from cationic surfactants, anionic surfactants, or non-ionic surfactants. Examples of cationic surfactants include quaternary amines, primary amine salts, diamine salts, and ethoxylated amines. Examples of non-ionic surfactants include block copolymers containing ethylene oxide, silicone surfactants, alkylphenol ethoxylates, and linear and secondary alcohol ethoxylates of alkyl group containing more than 8 carbon atoms.

Examples of cationic surfactants include quaternary amines, primary amine salts, diamine salts, and ethoxylated amines. Examples of non-ionic surfactants include block copolymers containing ethylene oxide, silicone surfactants, alkylphenol ethoxylates, and linear and secondary alcohol ethoxylates of alkyl group containing more than 8 carbon atoms.

Examples of anionic surfactants include sulfonates, carboxylates, and phosphates. In one embodiment, anionic surfactants useful in preparing the froth from the aqueous dispersion may be selected from carboxylic acid salts and ester amides of carboxylic fatty acids, preferably fatty acids comprising from 12-36 carbon atoms, e.g., stearic or lauric acid, palmitic, myristic, oleic, linoleic, ricinoleic, erucic acid and the like.

In some embodiments, the surfactant may include amphoteric surfactants such as aminopropionates, amphoteric sulfonates, betaines, imidazoline based amphoterics, and sultaines, among others. For example, the surfactant may be derived from an imidazoline and can either be the acetate form (containing salt) or the propionate form (salt-free). Examples of suitable amphoteric surfactants include surfactants such as lauramidopropyl betaine, sodium laurimino dipropionate, cocoamidopropyl hydroxyl sultaine, alkylether hydroxypropyl sultaine, sodium capryloampho hydroxypropyl sulfonate, disodium capryloampho dipropionate, sodium cocoamphoacetate, disodium cocoamphodiacetate, sodium cocoamphopropionate, disodium octyl iminodipropionate, sodium cocoampho hydroxypropyl sulfonate, disodium lauryl iminodipropionate, sodium stearoampho acetate, and disodium tallow iminodipropionate, among others. Other amphoteric surfactants known in the art may also be used.

In some embodiments, the frothing surfactant may be used in an amount such that the resulting froth, as described below, may contain from 0.01 to 10.0 weight percent frothing surfactant based on the dry weight of the thermoplastic polymer. In other embodiments, the froth may contain from 0.02 to 3.0 weight percent frothing surfactant based on the dry weight of the thermoplastic polymer; from 0.03 to 2.5 weight percent based on the dry weight of the thermoplastic polymer in other embodiments; and from 0.05 to 10.0 weight percent based on the dry weight of the thermoplastic polymer in yet other embodiments. In various other embodiments, the frothing surfactant may be present in the froth in an amount ranging from a lower bound of 0.01, 0.02, 0.03, 0.04, or 0.05 weight percent based on the dry weight of the thermoplastic polymer to an upper bound of 2.0, 2.5, 3.0, 4.0, 5.0, or 10.0 weight percent based on the dry weight of the thermoplastic polymer, in any combination of given upper and lower bounds.

In addition to the above listed surfactants, other surfactants may be used which do not detrimentally affect the frothing or stability of the froth. In particular additional anionic, zwitterionic or nonionic surfactants may be used in combination with the above listed surfactants

Additives

The polymers, dispersions, froths, and foams disclosed herein may optionally contain fillers in amounts, depending on the application for which they are designed, ranging from about 2-100 percent (dry basis) of the weight of the thermoplastic resin. These optional ingredients may include, for example, calcium carbonate, titanium dioxide powder, polymer particles, hollow glass spheres, fibrillated fibers, polymeric fibers such as polyolefin based staple monofilaments and the like. Foams designed for use in the absorbent articles may contain bulk liquid-absorbing material, such as short cotton fiber or other cellulose fiber evenly distributed throughout the polymer foam.

Additives may be used with the thermoplastic polymers, dispersion stabilizing agents, frothing surfactants, or fillers without deviating from the scope of the present disclosure. For example, additives may include a wetting agent, surfactants, anti-static agents, antifoam agent, anti block, wax-dispersion pigments, a neutralizing agent, a thickener, a compatibilizer, a brightener, a rheology modifier, a biocide, a fungicide, and other additives known to those skilled in the art.

Additives and adjuvants may be included in any formulation comprising the thermoplastic polymers. Suitable additives include fillers, such as organic or inorganic particles, including clays, talc, titanium dioxide, zeolites, powdered metals, organic or inorganic fibers, including carbon fibers, silicon nitride fibers, steel wire or mesh, and nylon or polyester cording, nano-sized particles, clays, and so forth; tackifiers, oil extenders, including paraffinic or napthelenic oils; and other natural and synthetic polymers, including other polymers according to embodiments of the invention.

The compositions disclosed herein may contain processing oils, plasticizers, and processing aids (collectively referred to as processing oils). Processing oils having a certain ASTM designation and paraffinic, napthenic or aromatic process oils are all suitable for use. In some embodiments, from 0 to 150 parts processing oils per 100 parts of total polymer may be employed; from 0 to 100 parts in other embodiments; and from 0 to 50 parts of oil per 100 parts of total polymer are employed in yet other embodiments. Higher amounts of processing oil may tend to improve the processing of the resulting product at the expense of some physical properties. Additional processing aids include conventional waxes, fatty acid salts, such as calcium stearate or zinc stearate, (poly)alcohols including glycols, (poly)alcohol ethers, including glycol ethers, (poly)esters, including (poly)glycol esters, and metal salts, especially Group 1 or 2 metal salts or zinc salt derivatives thereof.

Compositions, including thermoplastic blends, may also contain anti-ozonants or anti-oxidants. The anti-ozonants may be physical protectants such as waxy materials that come to the surface and protect the thermoplastic from oxygen or ozone or they may be chemical protectors that react with oxygen or ozone. Suitable chemical protectors include styrenated phenols, butylated octylated phenol, butylated di(dimethylbenzyl) phenol, p-phenylenediamines, butylated reaction products of p-cresol and dicyclopentadiene (DCPD), polyphenolic anitioxidants, hydroquinone derivatives, quinoline, diphenylene antioxidants, thioester antioxidants, and blends thereof Some representative trade names of such products are WINGSTAY™ S antioxidant, POLYSTAY™ 100 antioxidant, POLYSTAY™ 100 AZ antioxidant, POLYSTAY™ 200 antioxidant, WINGSTAY™ L antioxidant, WINGSTAY™ LHLS antioxidant, WINGSTAY™ K antioxidant, WINGSTAY™ 29 antioxidant, WINGSTAY™ SN-1 antioxidant, and IRGANOX™ antioxidants. In some applications, the anti-oxidants and anti-ozonants used will preferably be non-staining and non-migratory.

For providing additional stability against UV radiation, hindered amine light stabilizers (HALS) and UV absorbers may be also used. Suitable examples include TINUVIN™ 123, TINUVIN™ 144, TINUVIN™ 622, TINUVIN™ 765, TINUVIN™ 770, and TINUVIN™ 780, available from Ciba Specialty Chemicals, and CHEMISORB™ T944, available from Cytex Plastics, Houston Tex., USA. A Lewis acid may be additionally included with a HALS compound in order to achieve superior surface quality, as disclosed in U.S. Pat. No. 6,051,681.

For some compositions, additional mixing processes may be employed to pre-disperse the anti-oxidants, anti-ozonants, carbon black, UV absorbers, and/or light stabilizers to form a masterbatch, and subsequently to form polymer blends there from.

Suitable crosslinking agents (also referred to as curing or vulcanizing agents) for use herein include sulfur based, peroxide based, or phenolic based compounds. Examples of the foregoing materials are found in the art, including in U.S. Pat. Nos. 3,758,643, 3,806,558, 5,051,478, 4,104,210, 4,130,535, 4,202,801, 4,271,049, 4,340,684, 4,250,273, 4,927,882, 4,311,628 and 5,248,729.

Thermoplastic compositions according to embodiments of the invention may also contain organic or inorganic fillers or other additives such as starch, talc, calcium carbonate, glass fibers, polymeric fibers (including nylon, rayon, cotton, polyester, and polyaramide), metal fibers, flakes or particles, expandable layered silicates, phosphates or carbonates, such as clays, mica, silica, alumina, aluminosilicates or aluminophosphates, carbon whiskers, carbon fibers, nanoparticles including nanotubes, wollastonite, graphite, zeolites, and ceramics, such as silicon carbide, silicon nitride or titania. Silane based or other coupling agents may also be employed for better filler bonding.

Examples of conventional fillers include milled glass, calcium carbonate, aluminum trihydrate, talc, bentonite, antimony trioxide, kaolin, fly ash, or other known fillers. A suitable filler loading may be from 0 to 200 parts of filler per 100 parts of dispersion solids (pphds). Fillers may be loaded in an amount of less than about 100 pphds in some embodiments, and less than about 80 pphds in other embodiments. Addition of inorganic fillers may enhance the production of the foam composite by faster drying speeds on the production line because the percentage of water to be removed on drying is lower.

Optionally a filler wetting agent may be used. A filler wetting agent may improve the compatibility of the filler and the polyolefin dispersions. Useful wetting agents include phosphate salts such as sodium hexametaphosphate. A filler wetting agent may be included at a concentration of at least about 0.5 pphds.

Thickeners may be useful to increase the viscosity of the thermoplastic polymer dispersions. For example, suitable thickeners include ALCOGUM™ VEP-II (a trade designation of Alco Chemical Corporation) and PARAGUM™ 241 (a trade designation of Para-Chem Southern, Inc.). Other suitable thickeners may include cellulose derivatives such as METHOCEL™ products (a trade designation of The Dow Chemical Company). Thickeners may be used in any amount necessary to prepare a dispersion of desired viscosity.

Thickening agents may be used when it is desired to control the viscosity of the aqueous phase and facilitate the transportation and distribution of, for example, fillers or fibers. Fillers may include clays, diatomaceous earth, calcium carbonate, and mineral fibers such as wallastonite; aqueous, latexes such as for example a styrene-butadiene. Thickening agents may include natural products such as xanthan gums, or chemical agents such as polyacrylamide polymers and gels. Other additives include mixing aids and emulsifiers.

The aqueous phase may also be used to introduce to other substances, such as fatty oils and functional additives, besides fibers and fillers when desiring to modify physical properties of the resulting polymer. If the resulting polymer is to be used in end applications where electrical or luminescent properties are required, the aqueous mixture may be used to introduce electrolytes so as to render the polymer electro-conductive, or fluorescent or phosphorescent additives so as to render the polymer luminescent.

While optional for purposes of the present disclosure, some components may be highly advantageous for product stability and durability during and after the manufacturing process. For example, inclusion of antioxidants, biocides, and preservatives may be highly advantageous in some embodiments.

Electrically Conductive Additive

Electrically conductive additives useful in embodiments disclosed herein may include graphite, carbon particles, intrinsically conductive polymers, metals, metal oxides, metal shavings, and combinations thereof. Graphite may include natural flake graphite. Metals may include low melting point metals, such as antimony, bismuth, cadmium, cesium, gallium, indium, lead, lithium, rubidium, tin, and zinc, high melting temperature metals, such as tungsten, molybdenum, tantalum, hafnium and niobium, and other metals with intermediate melting points such as copper, zinc, aluminum, iron, nickel and cobalt. In other embodiments, metals useful in embodiments may include silver, gold, platinum, and palladium. In yet other embodiments, a silver-coated copper powder may be used.

In other embodiments, the above metals may be reacted to form compounds or ceramic phases including metal hydrides, oxides, carbides, nitrides, chlorides, fluorides, borides, sulfides, phosphides, selenides, tellurides, and arsenides. In other embodiments, the conductive additive may include indium-tin oxide or antimony-tin oxide. In other embodiments, the conductive additive may include tin oxide and antimony oxide. In select embodiments, the conductive additive may include a mixture of titanium dioxide and antimony-doped tin oxide. In other embodiments, combinations of the above conductive additives may be used.

The electrically conductive additive may be comprised of particles of various shapes, such as spheres, rods, fibers, flakes, and the like, and combinations thereof. The electrically conductive additive may be comprised of conducting particles having a size between about 0.01 and about 100 microns in some embodiments; between about 0.1 and about 10 microns in other embodiments; and between 1 and 5 microns in yet other embodiments.

Electrically conductive additives may be characterized by having an aspect ratio number, the conductive particle's length divided by its width. For example, a perfect sphere has an aspect ratio of one. The longer the particle (i.e., the more rod-like the particle), the higher the aspect ratio. Generally, for a conductive additive having a high aspect ratio, less conducting agent is needed to provide the same electrical conductivity in an object when compared to a conducting agent made of a similar conducting agent but having a lower aspect ratio. In some embodiments, the aspect ratio of the conductive additive particles may be equal to or greater than about 2; equal to or greater than about 3 in other embodiments; and equal to or greater than about 4 in other embodiments.

In some embodiments, the electrically conductive additive may have an electrical resistivity less than or equal to 0.6 Ωm. In other embodiments, the electrically conductive additive may have an electrical resistivity from 0.001 to 0.1 Ωm; from 0.005 to 0.09 Ωm in other embodiments; and from 0.01 to 0.08 Ωm in yet other embodiments. In some applications, if significantly higher conductivity is desired, appropriate materials may be selected.

In other embodiments, the electrically conductive additive may be characterized by having an acicular or needle-like shape. Acicular particles useful in embodiments disclosed herein may have a major axis size ranging from 0.1 microns to 10 microns, and may have an aspect ratio equal to or greater than 10. In other embodiments, acicular particles may have a major axis size ranging from 0.5 to 5 microns, and may have an aspect ratio equal to or greater than 11. In other embodiments, the aspect ratio of the acicular particles may be equal to or greater than 13; and equal to or greater than about 15 in yet other embodiments.

One example of an acicular electrically conductive additive is acicular electroconductive titanium dioxide FT1000, available from Ishihara Sangyo Kaisha, LTD. FT1000 is a complex mixture of titanium dioxide and antimony-doped tin oxide, which may be provided in the form of acicular fine particles having an electrical resistivity from 0.02 to 0.1 Ωm, and an aspect ratio of greater than 11. FT3000 is a complex mixture of titanium dioxide and antimony-doped tin oxide, which may be provided in the form of acicular fine particles having an electrical resistivity from 10 to 0.6 Ωm, and an aspect ratio of greater than 11.

In various embodiments, acicular shaped electrically conductive additives may increase the physical strength of films and moldings, and may result in smaller loading amounts required to obtain the desired conductance as compared to otherwise-shaped conductive particles. In some embodiments, electrically conductive additives may provide excellent chemical and physical stability against humidity. In other embodiments, electrically conductive additives may provide a natural whiteness that makes the resulting coating or film easy to color.

Substrate

In some embodiments, substrates may include woven, knitted, and non-woven fibrous webs. In other embodiments, the substrates may be formed from or coated with the above mentioned thermoplastic polymer dispersions to form coated substrates useful in embodiments of the electrically conductive polymeric sheets disclosed herein.

In some embodiments, the substrates may be formed from fibers such as synthetic fibers, natural fibers, or combinations thereof. Synthetic fibers include, for example, polyester, acrylic, polyamide, polyolefin, polyaramid, polyurethane, regenerated cellulose, and blends thereof. Polyesters may include, for example, polyethylene terephthalate, polytriphenylene terephthalate, polybutylene terephthalate, polylatic acid, and combinations thereof. Polyamides may include, for example, nylon 6, nylon 6,6, and combinations thereof. Polyolefins may include, for example, propylene based homopolymers, copolymers, and multi-block interpolymers, and ethylene based homopolymers, copolymers, and multi-block interpolymers, and combinations thereof. Polyaramids may include, for example, poly-p-phenyleneteraphthalamid (KEVLAR®), poly-m-phenyleneteraphthalamid (NOMEX®), and combinations thereof. Natural fibers may include, for example, wool, cotton, flax, and blends thereof.

The substrate may be formed from fibers or yarns of any size, including microdenier fibers and yarns (fibers or yarns having less than one denier per filament). The fabric may be comprised of fibers such as staple fiber, filament fiber, spun fiber, or combinations thereof. The substrate may be of any variety, including but not limited to, woven fabric, knitted fabric, non-woven fabric, or combinations thereof.

Substrates that may be used in embodiments of the conductive polymeric sheets disclosed herein may include woven or non-woven, natural or synthetic, components, fibers, films, foams, and fabrics. In other embodiments, substrates may include bicomponent fibers, multi-layer films, metals, textiles, and ceramics. Non-wovens may include elastic non-wovens and soft non-wovens. In other embodiments, substrates may include fabrics or other textiles, porous films, and other non-wovens, including coated substrates. In certain embodiments, the substrate may be a soft textile, such as a soft or elastic non-woven, such as an elastomeric polyolefin or a polyurethane, for example. Wovens and/or knits made from microdenier fibers may also provided the desired substrate performance.

In some embodiments, the non-wovens may be based on polyolefin mono-component fibers, such as polyethylene or polypropylene. In other embodiments, bicomponent fibers may be used, for example where the core is based on a polypropylene and the sheath may be based on polyethylene. It should be understood that the fibers used in embodiments of the substrate may be continuous or non-continuous, such as staple fibers.

One example of a suitable soft non-woven is described in WO2005111282A1, disclosing a non-woven material having a fuzz/abrasion resistance of less than 0.5 mg/cm², and a flexural rigidity of less than or equal to 0.043*Basis Weight−0.657 mN·cm. (Basis weight may be determined by measuring the weight of a known area of fabric. For example, basis weight may be determined according to ASTM D 3776. Abrasion loss, or the amount of fuzz generated during abrasion, may be measured by the rub test. The rub test is performed by rubbing sandpaper of a defined grit across the surface of the sample with a controlled force. The sample is weighed before and after the test and weight loss is measured to determine the amount of fuzz formed and removed from the surface by the sandpaper.) The non-woven material may have a basis weight greater than 15 grams/m², a machine direction (MD) tensile strength of more than 25 N/5 cm in MD (at a basis weight of 20 grams/m²), and a consolidation area of less than 25%. In other embodiments, a spun-bond non-woven fabric may be made using fibers having a diameter in a range of from 0.1 to 50 denier.

An additional specific example of a suitable soft non-woven is described in WO2005111291A1, disclosing a non-woven material having a fuzz/abrasion resistance of less than 0.7 mg/cm2 and a flexural rigidity of less than 0.15 mN·cm. The non-woven material may have a basis weight greater than 15 grams/m², a tensile strength of more than 10 N/5 cm MD and 7 N/5 cm cross direction (CD) (at a basis weight of 20 GSM), and a consolidation area of less than 25%. In other embodiments, a fiber from 0.1 to 50 denier may be formed from a polymer blend, wherein the polymer blend includes a) from 40 weight percent to 80 weight percent by weight of the polymer blend of a first polymer which is a homogeneous ethylene/a-olefin interpolymer having: 1) a melt index of from 1 to 1000 grams/10 minutes, and 2) a density of from 0.870 to 0.950 grams/cc, and b) from 60 to 20 percent by weight of a second polymer which may be an ethylene homopolymer or an ethylene/a-olefin interpolymer having: 1) a melt index of from 1 to 1000 grams/10 minutes, and 2) a density which is at least 0.01 grams/cc greater than the density of the first polymer.

Additionally, a web having similar physical properties to those described above may also be utilized. The web structure may be formed from individual fibers, filaments, or threads which are interlaid, but not in an identifiable manner. Non-woven fabrics or webs have been formed from many processes such as melt blowing, spun-bonding, electrospun, and bonded carded web processes. The basis weight of the non-wovens may range from 25 g/m² to greater then 150 g/m².

In some embodiments, elastic non-wovens, such as described in U.S. Pat. No. 6,994,763 may be used. The elastic non-woven may be based on bicomponent fibers, where the core component may an elastomeric polymer and the sheath component may a polyolefin. The non-woven may have a basis weight ranging from 20 g/m² to 150 g/m² and may be produced on spun-bond technology which has bicomponent capability. Representative examples of commercially available elastomers for the core component of the bicomponent fiber may include the following polymers: KRATON® Polymers, ENGAGE™ polymers, VERSIFY™ elastomers, INFUSE™ olefin block copolymers, VISTAMAXX™ polyolefin elastomers, VECTOR™ polymers, polyurethane elastomeric materials (“TPU”), polyester elastomers, and heterophasic block copolymers.

Representative materials for the sheath component may include polyolefin based homo- and co-polymers. The polyolefin polymers may include polypropylene homopolymer, polypropylene random copolymers, polypropylene impact copolymers, and polyethylenes. In some embodiments, the polyethylenes may have a density ranging from 0.925 g/cm³ to 0.965 g/cm³.

In other embodiments, suitable elastic non-wovens may be formed from one or more “elastomeric” polymers. The term “elastomeric” generally refers to polymers that, when subjected to an elongation, deform or stretch within their elastic limit. For example, spun-bonded fabrics formed from elastomeric filaments typically have a root mean square average recoverable elongation of at least about 75% based on machine direction and cross direction recoverable elongation values of the fabric after 30% elongation of the fabric and one pull. Advantageously, spun-bonded fabrics formed from elastomeric filaments typically have a root mean square average recoverable elongation of at least about 65% based on machine direction and cross direction recoverable elongation values of the fabric after 50% elongation of the fabric and one pull.

In other embodiments, apertured films may be utilized as a layer(s) of the composite structures or laminates described herein. Use of apertured films may increase the strength of the structure. Additionally the apertured films may provide for a through-thickness conductive path following application of a coating to one or both surfaces of the film.

Descriptions of apertured films may be found in WO200080341A1 and U.S. Pat. Nos. 3,929,135 and 4,324,246. Apertured films may include thin polymeric films with small openings space uniformly across the width of the film. Apertured films are commonly used for use in body contacting absorbent and non-absorbent articles such as baby diapers, adult incontinent articles, sanitary napkins or panty liners, facial wipes, body wipes, articles of clothing, hospital bed sheets and the like.

Non-woven substrates may include mono- and bi-component fibers, spun-bond, having a basis weight ranging from 25 g/m² to 150 g/m² or greater in some embodiments; and a basis weight ranging from 25 to 60 g/m² in other embodiments. Basis weight may be determined by measuring the weight of a known area of fabric. For example, basis weight may be determined according to ASTM D 3776.

In some embodiments, substrates may be formed from the thermoplastic resins described above. In other embodiments, substrates may include films, fabrics, and foams formed from the above described thermoplastic resins. Substrates formed from porous or apertured films and fabrics and open-celled foams may advantageously provide for a through-thickness conductive path through the substrate following the coating process.

Electrically Conductive Coatings

Embodiments of the electrically conductive coatings may be formed by coating a substrate with dispersions, froths, or foams formed from the thermoplastic polymers and conductive additives described above. In some embodiments, the electrically conductive coatings may have an electrical DC surface resistance less than or equal to 20Ω (ohms) at a distance of 2.54 cm (1 inch). In other embodiments, the conductive coatings may have an electrical DC surface resistance from 0.01 to 20Ω at a distance of 2.54 cm (1 inch); from 0.1 to 15Ω at a distance of 2.54 cm (1 inch) in other embodiments; and from 0.5 to 10Ω at a distance of 2.54 cm (1 inch) in yet other embodiments. In some embodiments, the electrically conductive coatings may have an electrical DC surface resistance less than or equal to 15Ω (ohms) at a distance of 5.08 cm (2 inches). In other embodiments, the conductive coatings may have an electrical DC surface resistance from 0.01 to 12Ω at a distance of 5.08 cm (2 inches); from 0.1 to 10Ω at a distance of 5.08 cm (2 inches) in other embodiments; and from 0.5 to 8Ω at a distance of 5.08 cm (2 inches) in yet other embodiments. Surface resistance of a material is the resistance to the flow of electrical current over the materials surface. Electrical resistance is measured using copper disks, having approximately 2.84 square centimeters (0.44 square inches) of contact area in contact with the same side of a sheet surface, and where the distance between copper disk outer circumferences is as indicated (2.54 cm, 5.08 cm, etc.). The electrical resistance test results are measured using a Wavetek HD110 Multimeter, for example.

Electrically conductive coatings described in various embodiments may be formed by coating or impregnating a substrate with the dispersions described above. The electrically conductive additive filled polymer may be applied via rolling, spray coating, brushing, casting, or other coating techniques. In some embodiments, the electrically conductive layer may be applied without an adhesive.

In other embodiments, electrically conductive coatings may be formed by coating a substrate with froths or foams formed from the above described dispersion. For preparing froths from the above described dispersions, a gaseous frothing agent is generally used. Examples of suitable frothing agents include: gases and/or mixtures of gases such as, for example, air, carbon dioxide, nitrogen, argon, helium. Frothing agents are typically introduced by introduction of a gas above atmospheric pressure into a dispersion to faun a homogeneous froth by mechanical shear forces during a predetermined residence time. In preparing the froths, it is preferred to mix all components of the dispersion and then blend the gas into the mixture.

The amount of air or other gas (where a gas in addition to or other than air is desirable) that may be incorporated in the froth may comprise at least 80% by volume in one embodiment, at least 85% by volume in another embodiment, and at least 90% by volume of the resultant froth in yet another embodiment. Initially, all components to be used in making the froth may be mixed together with mild agitation to avoid entrapping air.

Once all of the ingredients are well mixed, the mixture may be exposed to high shear mechanical mixing. During this step, the bulk viscosity of the mixture may increase as more air is entrapped within the continuous aqueous phase until a non-flowable, stiff froth is formed. The mixing time necessary to obtain froths of a desired density may vary with amount and type of froth stabilizing surfactant and the amount of mechanical shear. Any mechanical mixing device capable of whipping air into a thickened aqueous dispersion, such as a kitchen blender/hand mixer, Hobart mixer fitted with a wire whip, or, on a larger scale, a COWIE & RIDING™ Twin Foamer (Cowie Riding Ltd.), or equipment such as an OAKES™ or FIRESTONE® frother may be used. The commercial foamers may also allow one to inject air into their high shear mixing head to obtain very low (less than 50 g/L) density froth. In commercial frothers, air can be added directly into the mixing head to assist in development of low density froth. The speed of the frothing device may be increased or decreased to attain a desired froth density.

Froths comprising the above described polymers and electrically conductive additives may also be formed as disclosed in PCT Application PCT/US2004/027593, filed Aug. 25, 2004, and published as WO2005/021622. In other embodiments, the polymers may also be crosslinked by any known means, such as the use of peroxide, electron beam, silane, azide, gamma irradiation, ultraviolet radiation, or other cross-linking techniques. The polymers may also be chemically modified, such as by grafting (for example by use of maleic anhydride (MAH), silanes, or other grafting agent), halogenation, amination, sulfonation, or other chemical modification.

When coating substrates in accordance with the present disclosure, the froths or dispersions containing the electrically conductive additive may be applied to the substrate topically or may be incorporated into the substrate by being pre-mixed with the fibers that are used to form the substrate. For instance, in one embodiment, the dispersion containing the electrically conductive additive may be sprayed onto the substrate. When the dispersion containing the electrically conductive additive is applied to the substrate, the dispersion may be uniformly applied over the surface area of the web or may be applied according to a particular pattern.

When topically applied to a substrate, the electrically conductive additive composition may be sprayed onto the substrate, extruded onto the substrate, or printed onto the substrate. When extruded onto the substrate, any suitable extrusion device may be used, such as a slot-coat extruder or a melt blown die extruder. When printed onto the substrate, any suitable printing device may be used. For example, an inkjet printer or a rotogravure printing device may be used.

The dispersion containing the electrically conductive additive may be incorporated at any point in the substrate manufacturing process. The point during the process at which the dispersion is incorporated into the substrate may depend upon the desired end properties of the product. For example, direct addition of the dispersion to a fibrous slurry, such as by injection of the dispersion into a slurry. When combined with the fibrous slurry, a retention aid may also be present within the dispersion. In other embodiments, a dispersion spray may be applied to a fibrous web substrate. For example, spray nozzles may be mounted over a moving web to apply a desired dose of the dispersions or froths to a fibrous web. Nebulizers may also be used to apply a light mist of the dispersion to a surface of a substrate web.

In other embodiments, the dispersion may be printed onto a substrate, such as by offset printing, gravure printing, flexographic printing, ink jet printing, digital printing of any kind, and the like. In other embodiments, the dispersion may be coated onto one or both surfaces of a substrate, such as by blade coating, air knife coating, short dwell coating, cast coating, and the like.

In other embodiments, the dispersion may be extruded onto the surface of a paper web. For example, extrusion of dispersions is disclosed in PCT publication, WO 2001/12414, published on Feb. 22, 2001, herein incorporated by reference to the extent that it is non-contradictory herewith.

In other embodiments, the dispersion may be applied to individualized fibers used to form a substrate. For example, comminuted or flash dried fibers may be entrained in an air stream combined with an aerosol or spray of a dispersion containing a conductive additive to treat individual fibers prior to incorporation into a non-woven or other fibrous product.

In other embodiment, the dispersion may be heated prior to or during application to a paper web. Heating the composition may lower the viscosity for facilitating application. For instance, the dispersion may be heated to a temperature of from about 50° C. to about 150° C.

In other embodiments, a substrate may be impregnated with a solution or slurry, wherein the dispersion penetrates a significant distance into the thickness of the substrate, such as at least about 20% of the thickness of the web, more specifically at least about 30% and most specifically at least about 70% of the thickness of the web, including completely penetrating the web throughout the full extent of its thickness. Penetration of the dispersion throughout the full extent of the substrate thickness may provide for a through-thickness conductive path, useful in various embodiments of the electrically conductive polymeric sheets described herein.

In other embodiments, the dispersion may be applied to a substrate using a foam application (e.g., foam finishing), either for topical application or for impregnation of the dispersion into the substrate under the influence of a pressure differential (e.g., vacuum-assisted impregnation of the foam). Principles of foam application of additives such as binder agents are described in U.S. Pat. Nos. 4,297,860 and 4,773,110.

In still other embodiments, the dispersion may be applied by padding of a solution of the dispersion compound into an existing substrate. Roller fluid feeding of the dispersion compound for application to the substrate may also be used.

In other embodiments, application of the dispersion compound by spray or other means to a moving belt or fabric which in turn contacts the substrate to apply the dispersion to the substrate, such as is disclosed in PCT publication, WO 01/49937 by S. Eichhorn, “A Method of Applying Treatment Chemicals to a Fiber-Based Planar Product Via a Revolving Belt and Planar Products Made Using Said Method,” published on Jun. 12, 2001.

In other embodiments, the dispersion may be applied after the substrate has been manufactured. That is, a dispersion formed in accordance with embodiments of the present invention may be added to a prior formed by product, as by a paper converter for example. Dispersions may be incorporated, coated, or impregnated during an “in-line process,” that is during the manufacturing of the substrate, or in an off-line application.

In some embodiments, the electrically conductive polymeric sheets may be formed by extrusion coating. The dispersion or froth may be extruded directly onto the desired substrate.

In other embodiments, the electrically conductive polymeric sheets may be formed by roll coating (doctor blade). The dispersion or froth may be applied to a continuous belt of substrate using a doctor blade a fixed height above the substrate. Dispersion or froth continuously fed to one side of the blade creates a constant pool of material. The moving substrate below the blade pulls from this pool of material with the thickness of the resultant coating to be fixed by the blade height. Additional layers of substrate or foam may be added as required. The resultant structure may then be dried to remove moisture and to aid in adhesion.

In other embodiments, the electrically conductive polymeric sheets may be formed by spray coating. The dispersion or froth may be sprayed onto desired substrate and subsequently dried.

In other embodiments, the electrically conductive polymeric sheets may be formed by curtain coating. The dispersion or froth may be applied via direct deposition onto a moving belt or substrate. The coating thickness is controlled by the dispersion or froth feed rate and the speed of the substrate below the curtain.

In other embodiments, the electrically conductive polymeric sheets may be formed by batch application. The dispersions or froths may be manually applied to a substrate surface. The surface may then be leveled using a knife blade and metering bars of desired thickness. The knife moves across the metering bars removing excess coating material from the surface creating a uniform height.

Additional processing techniques may include thermoforming, embossing, hydroentaglement, air lacing, exposure to infrared heat, and addition of surface fibers, such as flocking techniques.

After the dispersion or froth is applied to a substrate, the material may be treated in such a manner to remove substantially all of the water present in the dispersion or the froth, resulting in a coated or impregnated substrate. Removal of the water is generally done by use of a suitable energy source such as an infrared oven, a conventional oven, microwave or heating plates. Drying can be at ambient temperature, or in an oven at temperatures from 50 to 200° C. The amount of dispersion or froth used to coat or impregnate a textile may vary widely, depending on the characteristics of the textile, the type of electrically conductive additive, and the desired coating weight and thickness.

In one embodiment, the electrically conductive coatings described herein may be prepared from the dispersions or froths by removing at least a portion of the liquid/aqueous element of the dispersion or froth. In other embodiments, electrically conductive coatings may be prepared from the dispersions or froths by removing at least a majority of the liquid/aqueous element of the froth. In yet other embodiments, the electrically conductive coatings may be prepared by removing substantially all of the liquid/aqueous element. In various embodiments, greater than 30 weight percent, greater than 50 weight percent, greater than 80 weight percent, greater than 90 weight percent, greater than 95 weight percent, greater than 98 weight percent, or greater than 99 weight percent of the liquid/aqueous element may be removed. In one embodiment, the dispersions or froths may be dried by heating in a forced air drying oven, at temperatures selected for optimum drying. In one embodiment, the dispersion or froth coated substrate may be heated to a temperature between about 60° and 120° C.

As the nature of the thermoplastic resin permits, processing may be conducted at the highest temperature feasible to remove water as rapidly as possible from the dispersion or froth without destroying the viscosity of the thermoplastic resin or without causing significant (e.g., more than 30 volume percent) collapse of the partially dried froth. In another embodiment, the drying temperature may be selected so as to not exceed the melting point temperature of the thermoplastic resin. In one embodiment, it may be desirable to dry the dispersions or froths at a temperature that approaches, but does not exceed the melting range of the thermoplastic resin. In another embodiment, it may be desirable to attain a temperature where the amorphous regions in the thermoplastic resin begin to coalesce while pseudo-crosslinking with the substrate.

Some embodiments of the electrically conductive coating may have an average thickness ranging from about 0.05 mm to 10 mm or more; from about 0.1 mm to 6 mm in other embodiments; and from 0.2 mm to 2.5 mm in yet other embodiments. Other embodiments of the electrically conductive coating may have an average thickness ranging from 0.05 mm to 2.0 mm; and from 1 to 1.5 mm in yet other embodiments. Articles comprising embodiments of the electrically conductive coating may include at least one layer of conductive coating having an average thickness ranging from 0.1 cm to 2.5 cm; from 0.5 cm to 2.0 cm in other embodiments; and from 1.0 cm to 1.5 cm in yet other embodiments. In other embodiments, one or more electrically conductive coatings may be laminated to a substrate, such as a non-woven or a polymeric film.

Drying of the dispersions and froth to form the desired electrically conductive coatings may be conducted in batch or continuous mode. Devices including, for example, conventional forced air drying ovens or banks of infrared heating lamps or dielectric heating devices, e.g., radio (typically operated at permitted frequency bands in the range between 1-100 MHz) and microwave (typically operated at permitted frequency bands in the range between 400 to 2500 MHz) frequency energy generating sources, lining a tunnel or chamber in which the dispersion froth may be placed or conveyed through, in a continuous fashion, may be employed for drying. A combination of such drying energy sources may be used, either simultaneously or sequentially applied, to dry a froth or dispersion to form a coating. In one embodiment, the drying may include the simultaneous use of a dielectric device and a forced air drying oven. The temperature of the drying operation may be selected according to the nature and the melting range of the thermoplastic resin (as determined by DSC) employed to prepare the coating. The dielectric heating frequency bands, permitted for industrial use in various countries, are designated in greater detail in the reference “Foundations of Industrial Applications of Microware and Radio Frequency Fields,” Rousy, G and Pierce, J. A. (1995).

The coatings described herein may adhere to a substrate. In some embodiments, the adhesive force between the coating and the substrate may be 0.18 N/cm (0.1 lbf/in) or greater. In other embodiments, the adhesive force between the coating and the substrate may be 0.26 N/cm (0.15 lbf/in) or greater; and 0.35 N/cm (0.2 lbf/in) or greater in yet other embodiments. Adhesive strength, or laminate peel strength, is a measure of the energy required to separate the layers per unit area. Adhesive strength is the average load per unit width of bond line required to part bonded materials, where the angle of separation is 180 degrees and separation rate is 15.2 cm/min (6 in/min) (ASTM D-903).

For many applications, formation of a continuous film is critical to achieving the desired conductivity. In the case of coatings on various substrates, failure to form a continuous film may cause pinholes to remain in the coating and may compromise the conductivity performance of the coating. Film formation may be enhanced by a variety of dispersion parameters including the incorporation of greater amounts (30% by weight of the total solids content of the dispersion and higher) of ethylene-acrylic (EAA) copolymer, neutralizing the EAA copolymer to a greater extent to form the corresponding salt (at least 50-60% neutralized up to 100%), and the use of a thermoplastic resin having a lower melting point. In certain embodiments, the thermoplastic resin may have a melting point less than 110° C. In other embodiments, the melting point may be less than 100° C.; and in yet other embodiments, the melting point can be less than 90° C.

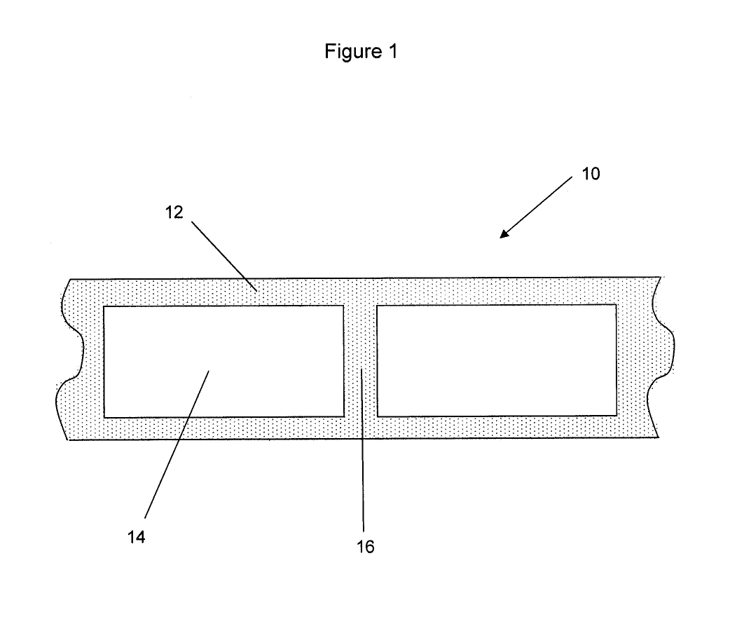

One example of an electrically conductive polymeric sheet 10 in accordance with embodiments disclosed herein is illustrated in FIG. 1. Conductive polymeric sheet 10 may be formed from an electrically conductive additive-filled polymeric coating 12 deposited on a substrate 14. In some embodiments, substrate 14 may be non-conductive.

In some embodiments, the substrate may be a porous or apertured non-woven substrate, where the pore space may absorb conductive material, allowing for conduction of a charge from one side of the sheet to the other. In other embodiments, the non-woven may be calendared, providing a path 16 for through-thickness conduction.

### Examples

Latex Samples

A styrene-butadiene copolymer latex (DL460, available from The Dow

Chemical Company, having approximately 47 weight percent solids) was diluted to approximately 20 weight percent solids. Where indicated for individual samples, a mixture of titanium dioxide and antimony-doped tin oxide (Titanium Dioxide FT1000, available from Ishihara Sanghyo Kaish, LTD) was mixed with the diluted latex solution to result in various filler loading fractions, described below.

Polyolefin Dispersion Samples

A polyolefin dispersion was formed with 100 parts AFFINITY™ GA1900 (an ethylene-octene copolymer having approximately 40 weight percent 1-octene, a density of about 0.87 g/cc, a melt index of 1000 g/10 minutes (ASTM D 1238, condition 190° C/2.16 kg), a Brookfield Viscosity of about 8200 cps at 177° C. (350° F.), and a melting point of about 63° C. (as determined by DSC at a scanning rate of about 10° C. per minute; available from The Dow Chemical Company, Midland, Mich.) and 6.4 parts of a C₁₈ mean, primary unsaturated carboxylic acid, melt kneaded at 120° C. in a twin screw extruder at a rate of 4.8 kg/h. Upon the melt kneaded resin, a 30.4 weight percent aqueous solution of potassium hydroxide was continuously fed into a downstream injection port at a rate of 0.2 kg/h (at a rate of approximately 4 weight percent of the total mixture). The resulting mixture was then further diluted with additional water at a rate of 4.8 kg/h, resulting in an aqueous dispersion having a solids content of approximately 50 weight percent and a pH from 9.5 to 10.5.

The polyolefin dispersion was then diluted to approximately 20 weight percent polymer solids. Where indicated for individual samples, a mixture of titanium dioxide and antimony-doped tin oxide (Titanium Dioxide FT1000, available from Ishihara Sanghyo Kaish, LTD) was mixed with the diluted latex solution to result in various filler loading fractions, described below.

Comparative Sample 1A

Approximately 10 grams of DL460, as described above, was diluted with approximately 15 grams de-ionized water, resulting in a solution having 20 weight percent solids. The diluted latex was then applied to a side of a 100 percent polypropylene non-woven sheet, and the coated sheet was dried, resulting in a dried latex layer coating on a 100 percent polypropylene substrate (no conductive additive).

Comparative Sample 2A

Approximately 10 grams of the Polyolefin Dispersion, as described above, was diluted with approximately 15 grams de-ionized water, resulting in a solution having 20 weight percent solids. The diluted dispersion was then applied to a side of a 100 percent polypropylene non-woven sheet, and the coated sheet was dried, resulting in a dried polyolefin layer coating on a 100 percent polypropylene substrate (no conductive additive).

Sample 3A

Approximately 10 grams of DL460, as described above, was diluted with approximately 15 grams de-ionized water, resulting in a solution having 20 weight percent solids. To this diluted solution was added 2.14 grams of FT1000. The aqueous latex solution was then applied to a side of a 100 percent polypropylene non-woven sheet, and the coated sheet was dried, resulting in a dried latex layer coating, having approximately 30 weight percent conductive material and approximately 70 weight percent styrene-butadiene copolymer, on a 100 percent polypropylene substrate.

Sample 4A

Approximately 10 grams of the Polyolefin Dispersion, as described above, was diluted with approximately 15 grams de-ionized water, resulting in a solution having 20 weight percent solids. To this diluted solution was added 1.67 grams of FT1000. This aqueous dispersion was then applied to a side of a 100 percent polypropylene non-woven sheet, and the coated sheet was dried, resulting in a dried polyolefin layer coating, having approximately 25 weight percent conductive material and approximately 75 weight percent polyolefin, on a 100 percent polypropylene substrate.

Comparative Sample 1B

Approximately 10 grams of DL460, as described above, was diluted with approximately 15 grams de-ionized water, resulting in a solution having 20 weight percent solids. The diluted latex was then applied to both sides of a 100 percent polypropylene non-woven sheet, and the coated sheet was dried, resulting in a dried latex layer coating both sides of a 100 percent polypropylene substrate (no conductive additive).

Comparative Sample 2B

Approximately 10 grams of the Polyolefin Dispersion, as described above, was diluted with approximately 15 grams de-ionized water, resulting in a solution having 20 weight percent solids. The diluted dispersion was then applied to both sides of a 100 percent polypropylene non-woven sheet, and the coated sheet was dried, resulting in a dried polyolefin layer coating both sides of a 100 percent polypropylene substrate (no conductive additive).

Sample 3B

Approximately 10 grams of DL460, as described above, was diluted with approximately 15 grams de-ionized water, resulting in a solution having 20 weight percent solids. To this diluted solution was added 2.14 grams of FT1000. The aqueous latex solution was then applied to both sides of a 100 percent polypropylene non-woven sheet, and the coated sheet was dried, resulting in a dried latex layer coating, having approximately 30 weight percent conductive material and approximately 70 weight percent styrene-butadiene copolymer, on both sides of a 100 percent polypropylene substrate.

Sample 4B

Approximately 10 grams of the Polyolefin Dispersion, as described above, was diluted with approximately 15 grams de-ionized water, resulting in a solution having 20 weight percent solids. To this diluted solution was added 1.67 grams of FT1000. This aqueous dispersion was then applied to both sides of a 100 percent polypropylene non-woven sheet, and the coated sheet was dried, resulting in a dried polyolefin layer coating, having approximately 25 weight percent conductive material and approximately 75 weight percent polyolefin, on both sides of a 100 percent polypropylene substrate.

Sample 5

Approximately 10 grams of the Polyolefin Dispersion, as described above, was diluted with approximately 15 grams de-ionized water, resulting in a solution having 20 weight percent solids. To 20 grams of this diluted solution was added 0.7 grams of FT1000. This aqueous dispersion was then applied to both sides of a 100 percent polypropylene non-woven sheet, and the coated sheet was dried, resulting in a dried polyolefin layer coating, having approximately 15 weight percent conductive material and approximately 85 weight percent polyolefin, on both sides of a 100 percent polypropylene substrate.

Sample 6

Approximately 10 grams of DL460, as described above, was diluted with approximately 15 grams de-ionized water, resulting in a solution having 20 weight percent solids. To 20 grams of this diluted solution was added 0.7 grams of FT1000. The aqueous latex solution was then applied to both sides of a 100 percent polypropylene non-woven sheet, and the coated sheet was dried, resulting in a dried latex layer coating, having approximately 15 weight percent conductive material and approximately 85 weight percent styrene-butadiene copolymer, on both sides of a 100 percent polypropylene substrate.

The conductivity of the ten samples described above was tested and compared to the conductivity of an uncoated polypropylene substrate. The point-to-point resistance test was measured using copper disks, having approximately 0.44 square inches of contact area in contact with the sheet surface, and where the distance between copper disk outer circumferences is given in the table below. The conductivity test results are given in Table 1, where “infinite” indicates the resistance level is beyond the measurement range of the instrument, a Wavetek HD110 Multimeter.

TABLE 1

| | Resistance at | Resistance at | Resistance at |
|---|---|---|---|
| | 2.54 cm (1 inch) | 5.1 cm (2 inches) | 7.6 cm (3 inches) |
| Sample | (ohms) | (ohms) | (ohms) |
| Uncoated PP | Infinite | Infinite | Infinite |
| C-1A | Infinite | Infinite | Infinite |
| C-2A | Infinite | Infinite | Infinite |
| 3A | 0.28 | 0.38 | 0.28 |
| 4A | 7.67 | 11.67 | 11.00 |
| C-1B | Infinite | Infinite | Infinite |
| C-2B | Infinite | Infinite | Infinite |
| 3B | 0.10 | 0.36 | 0.14 |
| 4B | 1.40 | 1.73 | 2.58 |
| 5 | Infinite | Infinite | Infinite |
| 6 | 0.93 | 1.05 | 1.58 |

The conductivity test results, as shown in Table 1, indicate that sufficient conductivity may be achieved on the surface of a substrate to provide for electrostatic dissipation. The amount and relative effectiveness may vary with both conductive filler loading levels and amount of coating deposited.

A cast film was made using 35 weight percent conductive filler (FT-1000) and 65 weight percent elastomeric polymer (a blend of 20 weight percent DOWLEX 2517 (an ethylene/1-octene copolymer having a melt index of 25 g/10 minutes and a density of 0.917 g/cc) and 80 weight percent AFFINITY EG 8185 (an polyolefin plastomer having a melt index of about 30 g/10 minutes and a density of about 0.885 g/cc, each available from The Dow Chemical Co., Midland, Mich.). The conductive filler and the elastomeric polymer were mixed using a Haake Rehocord 90 in a 200 cc bowl at 150° C. at 20 rpm for 5 minutes. The resulting mixture was then extruded at 155° C. using a slit die, resulting in a film 0.38 mm (1.5 mil) thick and 15.24 cm (6 inches) wide. The cast film requires approximately 0.17 grams of conductive filler per 10.16 cm by 10.16 cm (4 inch by 4 inch) sheet having a 0.38 mm (1.5 mil) thickness. Based on weight, the corresponding amount of filler employed in the above described samples is given in Table 2.

TABLE 2

| | Conductive | Polymeric | Grams filler used |
|---|---|---|---|
| | Material in | Material in | per sheet for a |
| Sample | coating (wt. %) | coating (wt. %) | 2-sided coating |
| Cast Film | 35 | 65 | 0.17 |
| 3A | 30 | 70 | 0.16 |
| 4A | 25 | 75 | 0.04 |
| 3B | 30 | 70 | 0.23 |
| 4B | 25 | 75 | 0.10 |
| 5 | 15 | 85 | 0.03 |
| 6 | 15 | 85 | 0.06 |

Each of coated substrate Samples 3A, 4A, 4B, and 6 exhibits sufficient conductivity yet employs less overall levels of filler than the conventionally cast conductive polymeric sheet. As the filler is the highest cost constituent, embodiments disclosed herein may provide for reducing the raw material costs for conductive polymeric sheets.

Advantageously, one or more embodiments described herein may provide for the production of improved conductive polymeric sheets, as compared to prior art compositions. Other embodiments disclosed herein may advantageously provide for a lower cost conductive polymeric sheet.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All priority documents are herein fully incorporated by reference for all jurisdictions in which such incorporation is permitted. Further, all documents cited herein, including testing procedures, are herein fully incorporated by reference for all jurisdictions in which such incorporation is permitted to the extent such disclosure is consistent with the description of the present invention.

What is claimed:

1. An electrically conductive article, comprising:
a substrate;
at least one electrically conductive layer disposed on the substrate;
wherein the conductive layer comprises:
a thermoplastic resin; and
from about 1 to 30 weight percent of at least one conductive additive based on a total weight of the thermoplastic resin and the at least one conductive additive; and
wherein the conductive article has a surface resistance between 0.001 to 20Ω at a test distance of 2.54 cm (1 inch).

2. The electrically conductive article of claim 1, wherein the electrically conductive article has a surface resistance between 0.001 and 12Ω at a test distance of 5.08 cm (2 inches).

3. The electrically conductive article of claim 1, wherein the thermoplastic resin comprises a styrene-butadiene copolymer; a polyethylene homopolymer, copolymer, or multi-block interpolymer; a polypropylene homopolymer, copolymer, or multi-block interpolymer; and mixtures thereof.

4. The electrically conductive article of claim 1, wherein the at least one electrically conductive additive comprises at least one of a graphite, a metal, a metal oxide, and mixtures thereof.

5. The electrically conductive article of claim 4, wherein the at least one electrically conductive additive comprises particles having an acicular shape.

6. The electrically conductive article of claim 1, wherein the at least one electrically conductive additive comprises a mixture of titanium dioxide and antimony-doped tin oxide.

7. The electrically conductive article of claim 6, wherein the mixture of titanium dioxide and antimony-doped tin oxide comprises particles having an acicular shape.

8. The electrically conductive article of claim 7, wherein the acicular particle has an aspect ratio of at least 11.

9. The electrically conductive article of claim 1, wherein the conductive additive comprises conductive particles having an average particle size of 10 microns or less.

10. The electrically conductive article of claim 1, wherein the substrate comprises a non-woven textile.

11. The electrically conductive article of claim 1, comprising:
a first electrically conductive layer disposed on a first side of the substrate; and
a second electrically conductive layer disposed on a second side of the substrate;
wherein the substrate is apertured, porous, or calendered, and wherein the first electrically conductive layer conductively connects with the second electrically conductive layer.

12. The conductive article of claim 11, wherein the first electrically conductive layer has a greater surface resistance than the second electrically conductive layer.

13. A method of making an electrically conductive article, the method comprising:
applying at least one electrically conductive layer to a substrate;
wherein the electrically conductive layer comprises:
a thermoplastic resin; and
at least one electrically conductive additive, wherein the conductive additive comprises from about 1 to 30 percent of a total weight of the thermoplastic resin and the at least one conductive additive; and
wherein the conductive article has a surface resistance between 0.001 to 20Ω at a test distance of 2.54 cm (1 inch).

14. The method of claim 13, wherein the electrically conductive article has a surface resistance between 0.001 and 12Ω at a test distance of 5.08 cm (2 inches).

15. The method of claim 13, wherein the thermoplastic resin comprises a styrene-butadiene copolymer; a polyethylene homopolymer, copolymer, or multi-block interpolymer; a polypropylene homopolymer, copolymer, or multi-block interpolymer; and mixtures thereof.

16. The method of claim 13, wherein the at least one electrically conductive additive comprises at least one of a graphite, a metal, a metal oxide, and mixtures thereof.

17. The method of claim 13, wherein the at least one electrically conductive additive comprises a mixture of titanium dioxide and antimony-doped tin oxide.

18. The method of claim 17, wherein the mixture of titanium dioxide and antimony-doped tin oxide comprises particles having an acicular shape.

19. The method of claim 18, wherein the acicular particle has an aspect ratio of at least 11.

20. The method of claim 13, wherein the electrically conductive additive comprises conductive particles having an average particle size of 10 microns or less.

21. The method of claim 13, wherein the substrate comprises a non-woven.

22. The method of claim 13, wherein the substrate comprises at least one of a fiber, a film, a foam, a woven, a fabric, a bicomponent fiber, a multi-layer film, a metal, a textile, and a ceramic.

23. The method of claim 13, further comprising:
applying a first electrically conductive layer to a first side of the substrate; and
applying a second electrically conductive layer to a second side of the substrate;
wherein the substrate is apertured, porous, or calendered, and wherein the first electrically conductive layer conductively connects with the second conductive layer.

24. The method of claim 23, wherein the first electrically conductive layer has a greater surface resistance than the second electrically conductive layer.

25. The method of claim 13, wherein the applying an electrically conductive layer comprises:
coating or impregnating a substrate with an aqueous dispersion comprising the thermoplastic resin, the electrically conductive additive, a dispersion stabilizing agent, and water; and
removing at least a portion of the water to form the electrically conductive layer.

26. The method of claim 13, wherein the applying an electrically conductive layer comprises:
coating or impregnating a substrate with a froth comprising the thermoplastic resin, the electrically conductive additive, a frothing surfactant, and water; and
removing at least a portion of the water to form the electrically conductive layer.

27. An aqueous dispersion comprising:
a thermoplastic resin;
at least one stabilizing agent;
at least one electrically conductive additive; and
water.

28. The aqueous dispersion of claim 27, wherein the thermoplastic resin comprises a styrene-butadiene copolymer; a polyethylene homopolymer, copolymer, or multi-block interpolymer; a polypropylene homopolymer, copolymer, or multi-block interpolymer; and mixtures thereof.

29. The aqueous dispersion of claim 27, wherein the at least one electrically conductive additive comprises from about 1 to 30 percent of a total weight of the thermoplastic resin, the at least one stabilizing agent, and the at least one electrically conductive additive.

30. The aqueous dispersion of claim 27, wherein the at least one electrically conductive additive comprises at least one of a graphite, a metal, a metal oxide, and mixtures thereof.

31. The aqueous dispersion of claim 27, wherein the at least one electrically conductive additive comprises a mixture of titanium dioxide and antimony-doped tin oxide.
